(19) United States
(12) Patent Application Publication
(10) Pub. No.: US 2013/0327144 A1
(43) Pub. Date: Dec. 12, 2013

(54) SENSOR

(71) Applicant: SAMSUNG ELECTRO-MECHANICS CO., LTD., Suwon (KR)

(72) Inventors: Jong Woon Kim, Suwon (KR); Jae Sang Lee, Suwon (KR); Won Kyu Jeung, Suwon (KR)

(21) Appl. No.: 13/903,689

(22) Filed: May 28, 2013

(30) Foreign Application Priority Data
May 29, 2012 (KR) 10-2012-0056903

(51) Int. Cl. G01P 15/02

(52) U.S. Cl. CPC G01P 15/02
USPC 73/514.01

(57) ABSTRACT

Disclosed herein is a sensor including a mass body; a fixing part provided so as to be spaced apart from the mass body; a first flexible part connecting the mass body and the fixing part to each other in a Y-axis; and a second flexible part connecting the mass body and the fixing part to each other in an X-axis, wherein the first flexible part has a width in an X-axis direction larger than a thickness in a Z-axis direction, and the second flexible part has a thickness in a Z-axis direction larger than a width in a Y-axis direction.

### CROSS REFERENCE TO RELATED APPLICATION

This application claims the benefit of Korean Patent Application No. 10-2012-0056903, filed on May 29, 2012, entitled “Sensor”, which is hereby incorporated by reference in its entirety into this application.

### BACKGROUND OF THE INVENTION

1. Technical Field

The present invention relates to a sensor.

2. Description of the Related Art Recently, a sensor has been used in various fields, for example, military such as an artificial satellite, a missile, an unmanned aircraft, or the like, vehicles such as an air bag, electronic stability control (ESC), a black box for a vehicle, or the like, hand shaking prevention of a camcorder, motion sensing of a mobile phone or a game machine, navigation, or the like.

The sensor generally adopts a configuration in which a mass body is adhered to an elastic substrate such as a membrane, or the like, in order to measure acceleration, angular velocity, force, or the like. Through the above-mentioned configuration, the sensor measures inertial force applied to the mass body to calculate the acceleration, or measures Coriolis force applied to the mass body to measure the angular velocity, and measures external force directly applied to the mass body to calculate the force.

Specifically, a scheme of measuring the acceleration and the angular velocity using the sensor is as follows. First, the acceleration may be calculated by Newton's law of motion “F=ma”, when “F” represents inertial force applied to the mass body, “m” represents a mass of the mass body, and “a” is acceleration to be measured. Among others, the acceleration a may be obtained by sensing the inertial force F applied to the mass body and dividing the sensed inertial force F by the mass m of the mass body that is a predetermined value. In addition, the angular velocity may be obtained by Coriolis force “F=2 mΩ×v”, when “F” represents the Coriolis force applied to the mass body, “m” represents the mass of the mass body, “Ω” represents the angular velocity to be measured, and “v” represents the motion velocity of the mass body. Among others, since the motion velocity v of the mass body and the mass m of the mass body are values known in advance, the angular velocity Ω may be obtained by detecting the Coriolis force (F) applied to the mass body.

Meanwhile, a sensor according to the prior art, which is disclosed in the prior art document below, has a beam extended to an X-axis direction and a Y-axis direction in order to drive the mass body or sense a displacement of the mass body. However, since the beam extended in the X-axis direction has basically the same rigidity as that of the beam extended in the Y-axis direction in the sensor according to the prior art, at the time of measuring acceleration, crosstalk may be generated or at the time of measuring angular velocity, interference of a resonant mode may be generated. Due to the crosstalk or the interference of the resonant mode, the sensor according to the prior art senses force in an undesired direction, such that sensitivity is decreased.

### PRIOR ART DOCUMENT

[Patent Document]

Patent Document 1 US20090282918 A1

### SUMMARY OF THE INVENTION

The present invention has been made in an effort to provide a sensor allowing a mass body to be displaced only by force in a desired direction by forming a flexible part so as to move the mass body only in a specific direction.

According to preferred embodiments of the present invention, there is provided a sensor including: a mass body; a fixing part provided so as to be spaced apart from the mass body; a first flexible part connecting the mass body and the fixing part to each other in a Y-axis; and a second flexible part connecting the mass body and the fixing part to each other in an X-axis, wherein the first flexible part has a width in an X-axis direction larger than a thickness in a Z-axis direction, and the second flexible part has a thickness in a Z-axis direction larger than a width in a Y-axis direction.

The mass body may rotate based on the X-axis. Bending stress may be generated in the first flexible part and torsion stress is generated in the second flexible part.

The second flexible part may be provided at a position higher than the center of gravity of the mass body based on the Z-axis direction.

The second flexible part may be provided at a position corresponding to the center of gravity of the mass body based on the X-axis direction.

The second flexible part may connect the mass body and the fixing part to each other at both sides thereof.

The second flexible part may connect the mass body and the fixing part to each other at one side thereof.

The first flexible part may connect the mass body and the fixing part to each other at both sides thereof.

The fixing part may surround the mass body.

The sensor may further include a sensing unit provided in the first flexible part to sense a displacement of the mass body.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view of a sensor according to a first preferred embodiment of the present invention;

FIG. 2 is a side view of the sensor shown in FIG. 1;

FIG. 3 is a plan view showing a movable direction of a mass body shown in FIG. 1;

FIG. 4 is a side view showing a movable direction of a mass body shown in FIG. 2;

FIGS. 5A to 5B are side views showing a process in which the mass body shown in FIG. 2 rotates based on an X-axis;

FIG. 6 is a plan view of a sensor according to a second preferred embodiment of the present invention; and

FIG. 7 is a side view of the sensor shown in FIG. 6.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

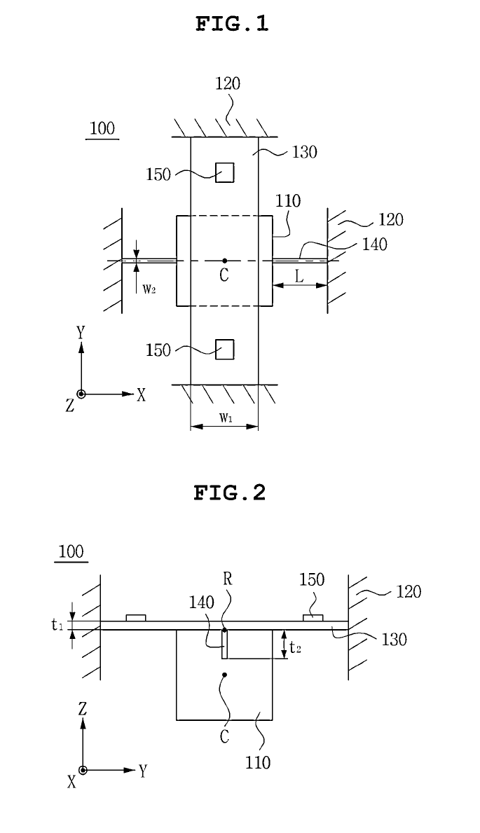

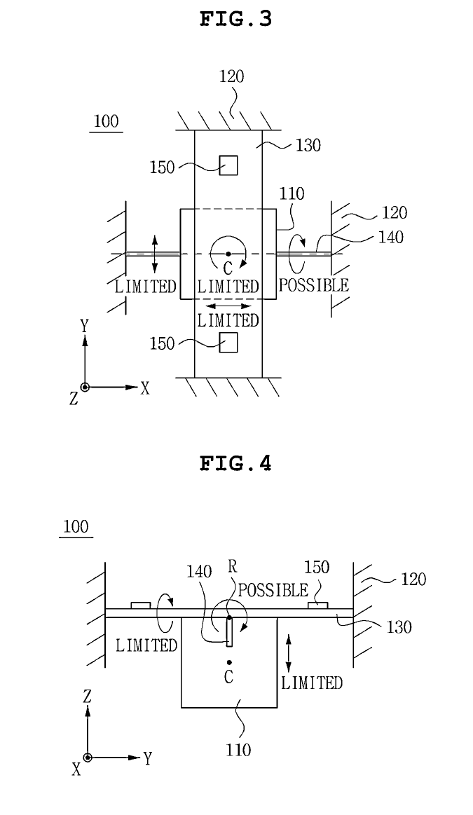

FIG. 1 is a plan view of a sensor according to a first preferred embodiment of the present invention, FIG. 2 is a side view of the sensor shown in FIG. 1, FIG. 3 is a plan view showing a movable direction of a mass body shown in FIG. 1, and FIG. 4 is a side view showing a movable direction of a mass body shown in FIG. 2.

As shown in FIGS. 1 and 2, the sensor 100 according to the preferred embodiment of the present invention includes a mass body 110, a fixing part 120 provided so as to be spaced apart from the mass body 110, a first flexible part 130 connecting the mass body 110 and the fixing part 120 to each other in a Y-axis direction, and a second flexible part 140 connecting the mass body 110 and the fixing part 120 to each other in an X-axis direction. Here, the first flexible part 130 has a width (w₁) in the X-axis direction larger than a thickness (t₁) in a Z-axis direction, and the second flexible part 140 has a thickness (t₂) in the Z-axis direction larger than a width (w₂) in the Y-axis direction.

The mass body 110, which is displaced by inertial force, Coriolis force, external force, and the like, is connected to the fixing part 120 through the first flexible part 130 and the second flexible part 140. Here, at the time of applying force to the mass body 110, the mass body 110 is displaced based on the fixing part 120 by bending of the first flexible part 130 and torsion of the second flexible part 140. In this case, the mass body 110 rotates based on the X-axis, which will be specifically described below. Meanwhile, even though the mass body 110 is shown in a square pillar shape, it has any shape such as a cylinder shape, a fan shape, or the like, that is known in the art, which is not limited thereto.

The fixing part 120 supports the first flexible part 130 and the second flexible part 140 to secure a space in which the mass body 110 may be displaced and serves as a reference in the case in which the mass body 110 is displaced. Here, the fixing part 120 is formed to surround the mass body 110, such that the mass body 110 is disposed at the center of the fixing part 120.

The first and second flexible parts 130 and 140, which serve to connect the fixing part 120 and the mass body 110 to each other so that the mass body 110 may be displaced based on the fixing part 120, are formed to be vertical to each other. That is, the first flexible part 130 connects to the mass body 110 and the fixing part 120 to each other in the Y-axis direction, and the second flexible part 140 connects the mass body 110 and the fixing part 120 to each other in the X-axis direction. Here, the first flexible part 130 and the second flexible part 140 may connect the mass body 110 and the fixing part 120 to each other at both sides thereof, respectively. Here, the first flexible part 130 has a width (w₁) in the X-axis direction larger than a thickness (t₁) in a Z axis direction, and the second flexible part 140 has a thickness (t₂) in the Z axis direction larger than a width (w₂) in the Y-axis direction.

As described above, the thickness (t₂) in the Z-axis direction of the second flexible part 140 is larger than the width (w₂) in the Y-axis direction. Therefore, as shown in FIG. 4, the mass body 110 has a limitation in rotating based on the Y-axis or being translated in the Z-axis direction; however, it may relatively and freely rotate based on the X-axis.

Specifically, as rigidity of the case in which the second flexible part 140 rotates based on the Y-axis is larger than that of the case in which the second flexible part 140 rotates based on the X-axis, the mass body 110 may freely rotate based on the X-axis; however, it has a limitation in rotating based on the Y-axis Similarly, as rigidity of the case in which the second flexible part 140 is translated in the Z-axis is larger than that of the case in which the second flexible part 140 rotates based on the X-axis, the mass body 110 may freely rotate based on the X-axis; however, it has a limitation in being translated in the Z-axis direction. Therefore, as a value of the second flexible part 140 (the rigidity in the case in which the second flexible part 140 rotates based on the Y-axis or the rigidity in the case in which the second flexible part 140 is translated in the Z-axis direction)/(the rigidity in the case in which the second flexible part 140 rotates based on the X-axis) becomes increased, the mass body 110 freely rotates based on the X-axis; however, it has a limitation in rotating based on the Y-axis or being translated in the Z-axis direction.

A relationship among the thickness (t₂) in the Z-axis direction, a length (L) in the X-axis direction, the width (w₂) of the Y-axis direction, and the rigidity in each direction of the second flexible part 140 may be defined as follows with reference to FIGS. 1 and 2.

(1) The rigidity in the case in which the second flexible part 140 rotates based on the Y-axis or the rigidity in the case in which the second flexible part 140 is translated in the Z-axis direction becomes ∝w₂×t₂³/L³

(2) The rigidity in the case in which the second flexible part 140 rotates based on the X-axis becomes ∝w₂³×t₂/L

According to the above two equations, the value of the second flexible part 140 (the rigidity in the case in which the second flexible part 140 rotates based on the Y-axis or the rigidity in the case in which the second flexible part 140 is translated in the Z-axis direction)/(the rigidity in the case in which the second flexible part 140 rotates based on the X-axis) is in proportion to (t₂/(w₂L))². However, since the second flexible part 140 according to the preferred embodiment of the present invention has the thickness t₂ in the Z-axis direction larger than a width w₂ in the Y-axis direction, (t₂/(w₂L))² is large. Therefore, the value of the second flexible part 140 (the rigidity in the case in which the second flexible part 140 rotates based on the Y-axis or the rigidity in the case in which the second flexible part 140 is translated in the Z-axis direction)/(the rigidity in the case in which the second flexible part 140 rotates based on the X-axis) becomes increased. Due to characteristics of the second flexible part 140, the mass body 110 freely rotates based on the X-axis; however, it has a limitation in rotating based on the Y-axis or being translated in the Z-axis direction (see FIG. 4).

Meanwhile, since the first flexible part 130 has relatively high rigidity in a length direction (Y-axis direction), the mass body 110 has a limitation in rotating based on the Z-axis or being translated in the Y-axis direction (see FIG. 3). In addition, since the second flexible part 140 has relatively high rigidity in a length direction (X-axis direction), the mass body 110 may have a limitation in being translated in the X-axis direction (see FIG. 3).

In the end, due to the characteristics of the first flexible part 130 and the second flexible part 140 as described above, the mass body 110 may rotate based on the X-axis; however, it may have a limitation in rotating based on the Y-axis or the Z-axis or in being translated in the Z-axis, the Y-axis or the X-axis direction. That is, the movable directions of the mass body 110 are defined as shown in the following Table 1.

TABLE 1

| | Whether or not |
|---|---|
| Movable Direction of Mass Body | Movement is Possible |
| rotation based on X-axis | possible |
| rotation based on Y-axis | limited |
| rotation based on Z-axis | limited |
| translation in X-axis direction | limited |
| translation in Y-axis direction | limited |
| translation in Z-axis direction | limited |

As described above, the mass body 110 may rotate based on the X-axis; however, it has a limitation in moving in other directions, such that the mass body 110 may be displaced only by the force in a desired direction (rotation based on the X-axis). In the end, the sensor 100 according to the present embodiment of the present invention may prevent crosstalk from being generated at the time of measuring the acceleration or the force, and remove the interference of the resonant mode at the time of measuring the angular velocity.

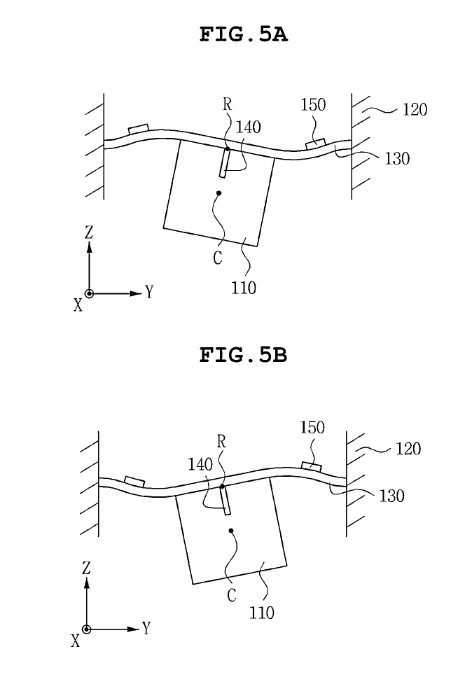

Meanwhile, FIGS. 5A to 5B are side views showing a process in which the mass body shown in FIG. 2 rotates based on an X-axis. As shown in FIGS. 5A to 5B, since the mass body 110 rotates based on the X-axis, which is an axis of rotation (R), bending stress formed by combining compression stress and tensile stress with each other is generated in the first flexible part 130, and torsion stress is generated based on the X-axis in the second flexible part 140. Here, in order to generate torque to the mass body 110, the second flexible part 140 may be provided at a position higher than the center of gravity (C) of the mass body 110 based on the Z-axis direction. In addition, as shown in FIG. 1, the second flexible part 14 may be provided at a position corresponding to the center of gravity (C) of the mass body 110 based on the X-axis so that the mass body 110 exactly rotates based on the X-axis direction.

Further, when being viewed based on an XY plane (see FIG. 1), since the first flexible part 130 is relatively wider than the second flexible part 140, the first flexible part 130 may have a sensing unit 150 sensing a displacement of the mass body 110. Here, the sensing unit 150 may sense the displacement of the mass body 110 rotating based on the X-axis. Here, the sensing unit 150 may be formed by a piezoelectric method, a piezoresistive method, a capacitance method, an optical method, and the like, which is not specifically limited thereto.

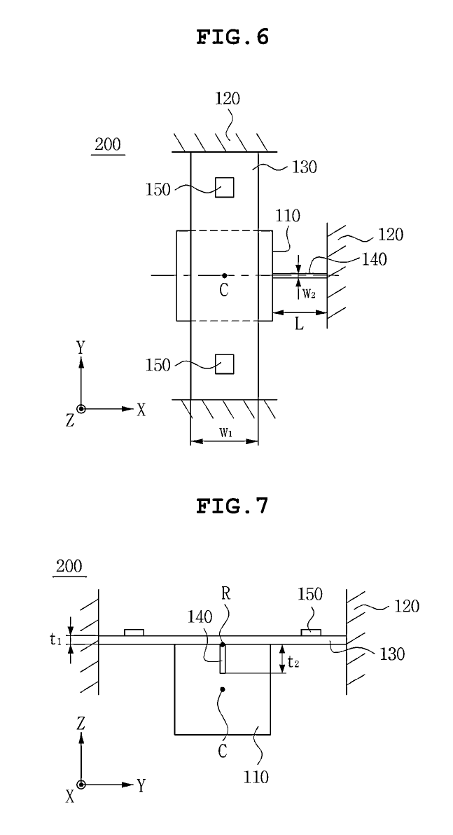

FIG. 6 is a plan view of a sensor according to a second preferred embodiment of the present invention; and FIG. 7 is a side view of the sensor shown in FIG. 6.

As shown in FIGS. 6 and 7, the sensor 200 according to the second preferred embodiment of the present invention has the same configuration as that of the sensor 100 according to the first preferred embodiment of the present invention, except for the second flexible part 140. Therefore, the sensor 200 according to the second preferred embodiment of the present invention will be described based on the second flexible part 140.

The second flexible part 140 of the sensor 100 according to the first embodiment of the present invention connects the mass body 110 and the fixing part 120 to each other at both sides of the second flexible part 140, respectively; however, the second flexible part 140 of the sensor 200 according to the second preferred embodiment of the present invention connects the mass body 110 and the fixing part 120 to each other at only one side thereof (see FIG. 6). Meanwhile, in the sensor 200 according to the second preferred embodiment of the present invention, the first flexible part 130 has a width (w₁) in the X-axis direction larger than a thickness (t₁) in a Z axis direction, and the second flexible part 140 has a thickness (t₂) in the Z axis direction larger than the width (w₂) in the Y-axis direction, similar to the sensor 100 according to the first preferred embodiment of the present invention.

As described above, since the second flexible part 140 has a width (w₂) in the Z-axis direction larger than a thickness (t₂) in the Y axis direction, the mass body 110 may relatively and freely rotate based on the X-axis; however, it may have a limitation in rotating based on the Y-axis or being translated in the Z-axis direction.

In addition, since the first flexible part 130 has relatively high rigidity in a length direction (Y-axis direction), the mass body 110 may have a limitation in rotating based on the Z-axis or being translated in the Y-axis direction. In addition, since the second flexible part 140 has relatively high rigidity in a length direction (X-axis direction), the mass body 110 may have a limitation in being translated in the X-axis direction.

In the end, due to the characteristics of the first flexible part 130 and the second flexible part 140 as described above, the mass body 110 may rotate based on the X-axis; however, it has a limitation in rotating based on the Y-axis or the Z-axis or in being translated in the Z-axis, the Y-axis or the X-axis direction. Therefore, the sensor 200 according to the second preferred embodiment of the present invention allows the mass body 110 to be displaced only by the force in a desired direction (rotation based on the X-axis). In the end, the sensor 200 according to the second present embodiment of the present invention may prevent the crosstalk from being generated at the time of measuring the acceleration or the force, and remove the interference of the resonant mode at the time of measuring the angular velocity.

Meanwhile, the sensors 100 and 200 according to the preferred embodiments of the present invention may be applied to an acceleration sensor, an angular velocity sensor, a force sensor, or the like, which is not specifically limited thereto.

As set forth above, with the sensor according to the preferred embodiment of the present invention, the flexible part is formed so as to move the mass body only in the specific direction, such that the mass body is displaced only by the force in a desired direction, thereby making it possible to prevent the crosstalk from being generated at the time of measuring the acceleration or the force and remove the interference of the resonant mode at the time of measuring the angular velocity.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention. In particular, the present invention describes based on the “X axis”, “Y axis”, and “Z axis”, which is defined for convenience of explanation and therefore, the scope of the present invention is not limited thereto.

Accordingly, any and all modifications, variations or equivalent arrangements should be considered to be within the scope of the invention, and the detailed scope of the invention will be disclosed by the accompanying claims.

What is claimed is:

1. A sensor comprising:
a mass body;
a fixing part provided so as to be spaced apart from the mass body;
a first flexible part connecting the mass body and the fixing part to each other in a Y-axis; and
a second flexible part connecting the mass body and the fixing part to each other in an X-axis,
wherein the first flexible part has a width in an X-axis direction larger than a thickness in a Z-axis direction, and
the second flexible part has a thickness in a Z-axis direction larger than a width in a Y-axis direction.

2. The sensor as set forth in claim 1, wherein the mass body rotates based on the X-axis.

3. The sensor as set forth in claim 2, wherein bending stress is generated in the first flexible part and torsion stress is generated in the second flexible part.

4. The sensor as set forth in claim 1, wherein the second flexible part is provided at a position higher than the center of gravity of the mass body based on the Z-axis direction.

5. The sensor as set forth in claim 1, wherein the second flexible part is provided at a position corresponding to the center of gravity of the mass body based on the X-axis direction.

6. The sensor as set forth in claim 1, wherein the second flexible part connects the mass body and the fixing part to each other at both sides thereof.

7. The sensor as set forth in claim 1, wherein the second flexible part connects the mass body and the fixing part to each other at one side thereof.

8. The sensor as set forth in claim 1, wherein the lint flexible part connects the mass body and the fixing part to each other at both sides thereof.

9. The sensor as set forth in claim 1, wherein the fixing part surrounds the mass body. to 10. The sensor as set forth in claim 1, further comprising: a sensing unit provided in the first flexible part to sense a displacement of the mass body.
